(19) United States
(12) Patent Application Publication
(10) Pub. No.: US 2006/0015750 A1
(43) Pub. Date: Jan. 19, 2006

(54) Storage of encrypted digital signals

(75) Inventors: Alexis S. R. Ashley, Redhill (GB); Octavius J. Morris, Redhill (GB)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/521,864

(22) PCT Filed: Jul. 16, 2003
(86) PCT No.: PCT/IB03/03229

§ 371 Date: Jan. 21, 2005

(30) Foreign Application Priority Data
Jul. 27, 2002 (GB) 0217462.1

(51) Int. Cl. G06F 12/14

(52) U.S. Cl. 713/193

(57) ABSTRACT

Digital video signals are encrypted by a broadcaster based on a key stream and transmitted to a receiver. At the receiver, the signals are decrypted using the broadcaster's keys and processed in unencrypted form to improve recording and/or playback operation. The processed signals are then re-encrypted using the broadcaster's keys, with appropriate time-shifting to align key changes with suitable boundaries in the video stream. The resulting encrypted signals are stored on a storage medium.

The present invention relates to the storage of digital signals, particularly but not exclusively to decrypting received digital video signals using a broadcaster's encryption system, manipulating the decrypted signals to improve recording/playback operation and re-encrypting the signals using the same encryption system.

When digital video signals are recorded, for example on a hard disk or optical disk, copy protection of the content is often required. The usual method of achieving this is to encrypt the signals prior to transmission using a cryptographic algorithm, also known as a cipher. The signals are fed into the cipher together with data known as a key, to generate an encrypted signal. Decryption is achieved by using the same algorithm and the same key to recover the original unencrypted signals. Normally, the cipher function does not change, but the keys change frequently. This type of key-based algorithm is generally known as a symmetric or secret-key algorithm.

Many digital television channels are encrypted for transmission, either to restrict access to only those consumers who have paid for the channels, or to limit the broadcast to a particular geographical region.

A known method of ensuring copy protection in recording such encrypted channels is to record the signal from the broadcast as is, without decoding the decryption used for the transmission.

Another known method is to encrypt the broadcast stream a second time before storage.

The storage of data in accordance with these methods is attractive for the broadcaster, since it maintains conditional access rights on the stored content and the content is encrypted with a technology trusted by the broadcaster. However, this solution is unattractive for the video storage device manufacturer, because it means that the storage device must store the signal in exactly the format it was received. This removes the ability to perform manipulations on the data to make the signal easier to record or to play back.

One method which removes this constraint is to decrypt the broadcast, process it and then re-encrypt it with a different cipher function and different set of keys. However, this method breaks the link with the broadcaster's encryption system and is therefore undesirable from the broadcaster's perspective.

The present invention aims to address the above problems.

According to the invention there is provided a method of storing a received digital signal which has been encrypted by an encryption key and transmitted in encrypted form, comprising the steps of decrypting the signal using a decryption key corresponding to the encryption key, processing the decrypted signal, re-encrypting the processed signal using the encryption key and storing the re-encrypted signal.

The processing may comprise operations which manipulate the signal to improve storage and/or playback operation, such as PID remapping, remultiplexing and/or transcoding.

By processing the signal in decrypted form and re-encrypting it using the same encryption system as was used for transmission by, for example, a broadcaster, manipulation of the signal to improve recording and/or playback is permitted, while maintaining the integrity of the broadcaster's encryption system.

According to the invention there is further provided a digital signal storage device for storing a digital signal which has been encrypted using an encryption key and transmitted in encrypted form, the device comprising decryption means for decrypting the signal using a decryption key corresponding to the encryption key, means for processing the decrypted signal, encryption means for re-encrypting the processed signal using the encryption key and means for storing the re-encrypted signal.

The decryption key may be the same as the encryption key and each of these keys may be one of a plurality of keys forming a key stream. The key stream may be delayed prior to re-encrypting the decrypted signal and the delay may be dependent on the processing being carried out.

According to the invention there is still further provided digital signal recording apparatus for recording a digital signal which has been encrypted using an encryption key and transmitted in encrypted form, the apparatus comprising a decryption module for decrypting the signal using a decryption key corresponding to the encryption key, a processor for processing the decrypted signal, an encryption module for re-encrypting the processed signal using the encryption key and a storage medium for storing the re-encrypted signal.

Embodiments of the invention will now be described, by way of example, with reference to the accompanying drawings, in which:

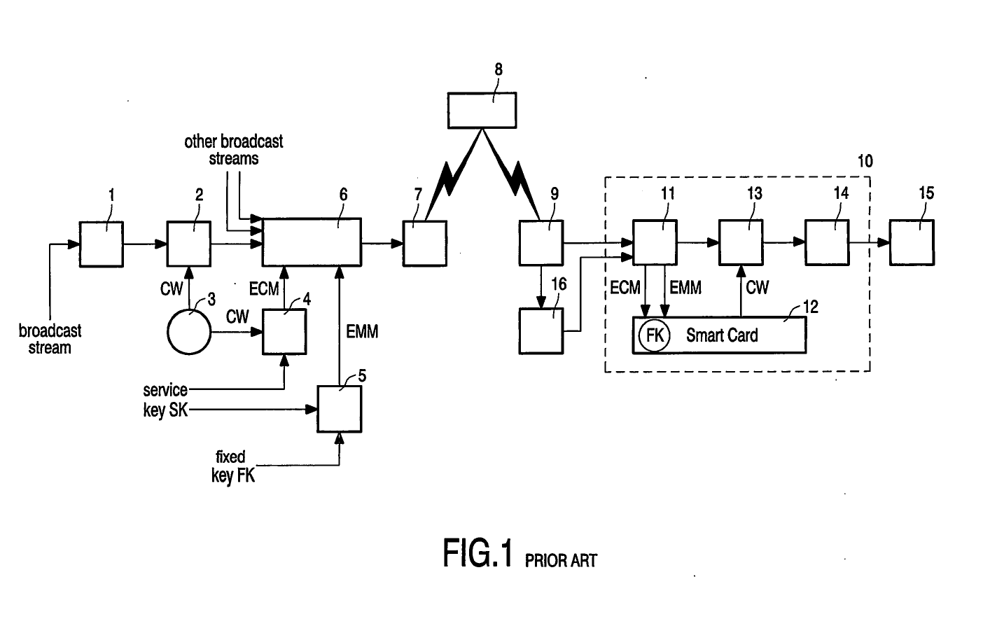

FIG. 1 is a schematic diagram of a conventional digital television broadcasting system;

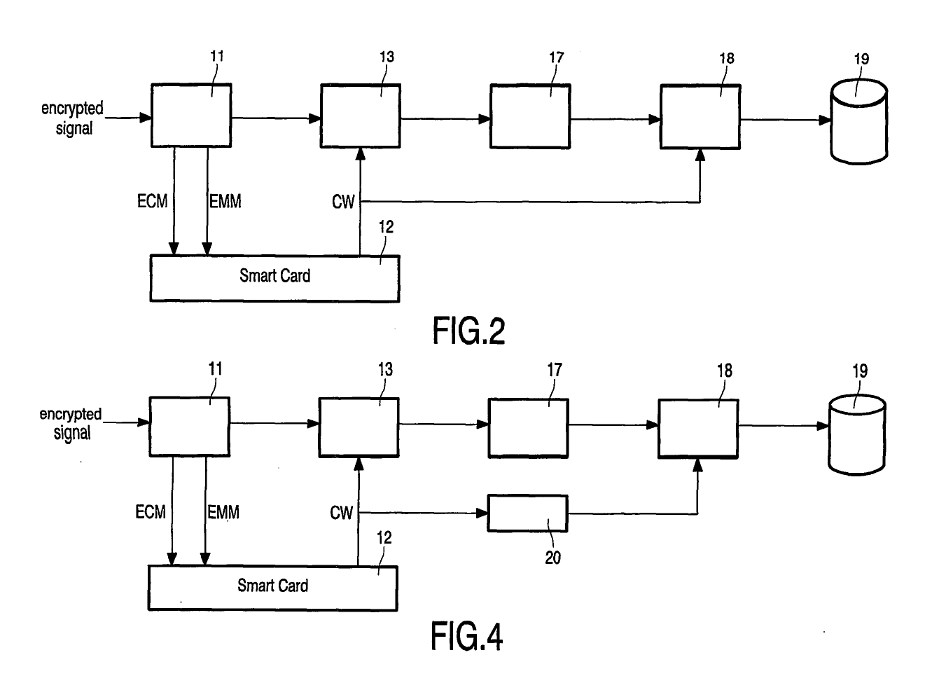

FIG. 2 is a schematic diagram illustrating a recording device according to the invention;

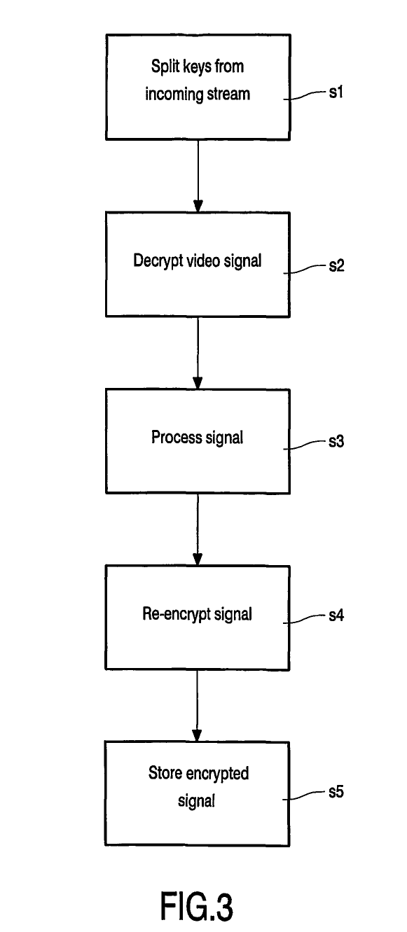

FIG. 3 is a flow diagram illustrating the operation of the recording device of FIG. 2; and

FIG. 4 is a schematic diagram illustrating a variation on the recording device of FIG. 2.

Referring to FIG. 1, in a conventional digital television broadcasting system, content to be broadcast, including for example, video, audio and data components, is encoded in an encoder 1 using an appropriate coding system, for example MPEG-II for digital broadcasting, in which a digital signal is represented as a stream of transport packets. The encoded broadcast stream is encrypted in a first encryption module 2 using a cryptographic key referred to as a control word CW, which is generated by a control word generator 3 in a manner which is well-known. The control word is encrypted into an Entitlement Control Message (ECM) by an ECM generator 4 using a service key SK, which is changed on, for example, a monthly basis. The ECM also includes access criteria which identify the service and the conditions required to access the service.

The service key is also encrypted by an encryption module 5 into another type of message, referred to as an Entitlement Management Message (EMM), using a fixed key FK which remains unchanged. EMM messages also carry details of the subscriber and his subscription.

The conventional form of ECM and EMM messages is defined in the international standard ISO IEC 13818-1, the entire contents of which are incorporated herein by reference.

The encrypted broadcast stream together with the ECM and EMM messages is multiplexed in a multiplexer 6 with other broadcast streams representing other programmes, together making up a subscription package from a particular service provider. The package is sent to a transmitter 7 from which it is transmitted, via a communications channel 8, for example a satellite or cable channel, using an appropriate modulation scheme. The encrypted broadcast stream is received at a subscriber's receiver 9, for example a satellite dish, and passed to the subscriber's decoder 10.

On receipt at the decoder, for example a set-top box (STB) 10, the received data is demultiplexed in a demultiplexer 11, to extract the required programme and its associated ECM and EMM messages. The extracted ECM and EMM messages are sent to a plug-in smart card 12. The smart card 12 uses the ECM and EMM messages to determine whether the subscriber has the right to view the broadcast and if so, to decrypt the control word CW.

The smart card 12 includes the fixed key FK which is also present at the broadcasting side. This is used to decrypt the service key SK provided in the EMM messages. The decrypted service key SK is then used to decrypt the control word CW, which is input to a decryption module 13 together with the scrambled broadcast stream to recover the original MPEG-II encoded broadcast stream. The encoded stream is passed to an MPEG-II decoder 14 which produces an output signal comprising audio, video and data components for display on the subscriber's television 15.

A recording device 16 located between the receiver 9 and the decoder 10 can be used to record the encrypted signal as it is received, for subsequent playback through the decoder 10.

The control word is changed at predetermined intervals, for example, every few seconds. A continuous stream of ECM messages is therefore required to decrypt the encrypted signal. The EMM message can be updated less frequently, for example, the encrypted service key can be sent monthly.

FIG. 2 illustrates a recording device according to the invention. This includes a demultiplexer 11, a smart card 12 and a decryption module 13 as in the conventional decoder 10 described above. The recording device further includes a processor 17, a second encryption module 18 and a storage medium 19, for example a hard disk or optical disk.

Referring to FIG. 3, the incoming digital stream is split by the demultiplexer 11 and the smart card 12 into an encrypted video stream and a stream of control words (step s1). Each stream is fed to the decryption module 13, which uses the control word stream to decrypt the encrypted video signal (step s2), as in the conventional decoder 10 described above. The decrypted video signal is then processed by the processor 17, with a view to manipulating it to make the signal easier to record or easier to play back (step s3). Examples of such manipulation include applying the conventional techniques of Packet Identification Number (PID) remapping, which refers to the transport packets in the MPEG-II scheme, as well as remultiplexing and transcoding. In more detail, PID remapping comprises changing the audio and video PID of the incoming signal, which is chosen by the broadcaster, to a fixed number chosen by the recording device. Remultiplexing relates to altering Packetized Elementary Stream (PES) structures to be aligned with video frames and conversion from transport streams to program streams, while transcoding relates to conversion of the MPEG-2 video to a lower bitrate MPEG-2 signal or conversion of the MPEG-2 video to another compression format such as H26L or MPEG-4.

After processing, the processed signal is re-encrypted at the second encryption module 18 using the control word stream from the smart card 12 (step s4). The second encryption module uses the same cryptographic algorithm, or cipher, as the first encryption module 2 at the broadcast side. The encrypted video signal is then stored on the storage medium 19 (step s5).

When the video is played back from the storage medium 19, the decoder will receive an encrypted stream which uses exactly the same cipher and keys as the original broadcast. The decoder is therefore unable to detect that the video signal has been manipulated.

As mentioned above, the control word used for encryption changes frequently. The changes are synchronised with the incoming video stream and occur on a suitable boundary in the stream, for example at the start of a transport stream packet. Depending on the processing which is applied after decryption, it is likely that key changes in the encrypted video output will not fall on convenient boundaries in the stream, since the processing will clearly take a finite time. If the decoder receiving the altered stream does not have its keys synchronised with the keys used by the re-encoding step, incorrect data will be produced in the receiver. To overcome this problem, a delay is introduced into the control word stream between the decryption module 11 and the second encryption module 18, as shown in FIG. 4 by the delay module 20. The delay module 20 adds a delay which allows a change in the control word being used to decrypt to be postponed until a suitable boundary occurs in the manipulated stream.

While embodiments of the invention have been described in relation to a symmetric key system where the encryption and decryption keys are identical, variations on this are possible. For example, the encryption and decryption keys may be different but correspond to one another, where for example the decryption keys can be calculated from the encryption keys and vice versa. Similarly, the cryptographic algorithms used for encryption and decryption need not be the same, but may be related functions. The only requirement is that a signal encrypted using the encryption algorithm and the encryption key can be recovered by applying the decryption algorithm and the decryption key. As an alternative to using a symmetric algorithm, a different type of cryptographic system, including a public key based system, may be used.

From reading the present disclosure, other variations and modifications will be apparent to persons skilled in the art. Such variations and modifications may involve equivalent and other features which are already known in the field of digital transmission and cryptographic systems and which may be used instead of or in addition to features already described herein. Although claims have been formulated in this application to particular combinations of features, it should be understood that the scope of the disclosure of the present invention also includes any novel features or any novel combination of features disclosed herein either explicitly or implicitly or any generalisation thereof, whether or not it relates to the same invention as presently claimed in any claim and whether or not it mitigates any or all of the same technical problems as does the present invention. The applicants hereby give notice that new claims may be formulated to such features and/or combinations of such features during the prosecution of the present application or of any further application derived therefrom.

1. A method of storing a received digital signal which has been encrypted by an encryption key (CW) and transmitted in encrypted form, comprising the steps of:
decrypting the signal using a decryption key (CW) corresponding to the encryption key;
processing the decrypted signal;
re-encrypting the processed signal using the encryption key; and
storing the re-encrypted signal.

2. A method according to claim 1, wherein the step of processing the decrypted signal includes manipulating it to improve storage and/or playback operation.

3. A method according to claim 1 or 2, wherein the decryption key (CW) is the same as the encryption key (CW).

4. A method according to any one of the preceding claims, wherein the encryption key is one of a plurality of keys forming a key stream.

5. A method according to claim 4, further comprising delaying the key stream after decrypting the signal and before re-encrypting the processed signal.

6. A method according to claim 5, including delaying the key stream in dependence on the processing being carried out on the decrypted signal.

7. A method according to claim 5 or 6, wherein the digital signal comprises a stream of transport packets, the method including synchronising the key stream with the transport packet stream.

8. A method according to any one of the preceding claims, wherein the step of processing the decrypted signal comprises performing the operations of Packet Identification Number (PID) remapping, remultiplexing or transcoding.

9. A digital signal storage device for storing a digital signal which has been encrypted using an encryption key (CW) and transmitted in encrypted form, the device comprising:
decryption means (13) for decrypting the signal using a decryption key corresponding to the encryption key;
means (17) for processing the decrypted signal;
encryption means (18) for re-encrypting the processed signal using the encryption key; and
means (19) for storing the re-encrypted signal.

10. A storage device according to claim 9, wherein the processing means (17) comprises means for manipulating the decrypted signal to improve storage and/or playback operation.

11. A storage device according to claim 10, wherein the processing means comprises means for performing the operations of Packet Identification Number (PID) remapping, remultiplexing and/or transcoding.

12. A storage device according to any one of claims 9 to 11, wherein the decryption key (CW) is the same as the encryption key (CW).

13. A storage device according to any one of claims 9 to 12, wherein the encryption key is one of a plurality of keys forming a key stream.

14. A storage device according to claim 13, further including delay means (20) for delaying the key stream prior to re-encrypting the decrypted signal.
